(19) United States
(12) Patent Application Publication
(10) Pub. No.: US 2007/0167319 A1
(43) Pub. Date: Jul. 19, 2007

(54) Heat-resistive catalyst and production method thereof

(75) Inventors: Kazuyuki Shiratori, Kanagawa-ken (JP); Katsuo Suga, Kanagawa-ken (JP); Masanori Nakamura, Kanagawa-ken (JP); Hironori Wakamatsu, Kanagawa-ken (JP); Hirofumi Yasuda, Kanagawa-ken (JP)

Correspondence Address: FOLEY AND LARDNER LLP;SUITE 500, 3000 K STREET NW, WASHINGTON, DC, 20007, US

(73) Assignee: Nissan Motor Co., Ltd.

(21) Appl. No.: 10/584,346

(22) PCT Filed: Dec. 2, 2004
(86) PCT No.: PCT/JP04/18333

§ 371 Date: Jun. 23, 2006

(30) Foreign Application Priority Data
Dec. 25, 2003 (JP) 2003-431009

(51) Int. Cl. B01J 23/00; B01J 21/00

(52) U.S. Cl. 502/304; 502/232; 502/240; 502/349; 502/350

(57) ABSTRACT

A high heat-resistive catalyser formed as a catalyst including a composite particle composed of a noble metal particle and a co-catalytic metal compound particle contacting, as a metal or as an oxide, with the noble metal particle, and a substrate carrying the noble metal particle and the co-catalytic metal compound particle, is produced by having a noble metal salt aqueous solution and a co-catalytic metal salt aqueous solution concurrently provided in a reverse micelle preparing reverse micellar solution containing a noble metal precursor and a co-catalytic metal precursor, and having a substrate carrying a composite particle comprising the noble metal precursor and the co-catalytic metal precursor concurrently reduced as a noble metal particle and a co-catalytic metal particle, respectively.

### TECHNICAL FIELD

The present invention relates to a heat-resistive catalyst adaptive as an exhaust-gas purifying catalyser to be mounted on a vehicle, and to a production method thereof.

### BACKGROUND ART

Along with a rising interest to the environment in recent years, the regulation to exhaust gases of automobile has been tightened with an increasing severity, involving improvements in engine system, accompanied by investigations for enhancement in performance of catalyst for purifying exhaust gases.

The exhaust-gas purifying catalyst has noble metal particles (e.g. of platinum (Pt), palladium (Pd)) held on surfaces of a carrying substrate (e.g. alumina (Al₂O₃)), for a conversion of harmful components (e.g. unburnt hydrocarbons (HC), carbon monoxide (CO)) contained in exhaust gases, by oxidization on noble metal particles, into harmless components (e.g. water, gas).

Noble metals to be active in catalysis are extremely expensive elements with an anxiety of resource exhaustion, which renders a large amount of use difficult.

Research and developments have been made for providing finer noble metal particles with extended surface areas to increase the contact area between exhaust gases and noble metal particles, allowing for noble metals to be reduced in amount of use. Besides, attempts are made to have co-catalytic metal particles held on a carrying substrate.

A reversed micelle method (micro-emulsification) is known as an applicable technique to provide fine noble metal particles. The reversed micelle method first admix, in an organic solvent, a surfactant, and an aqueous solution containing e.g. noble metal element as a catalytically active component, for preparation of an emulsion having, in a reverse micelle formed in the organic solvent, the aqueous solution containing noble metal element. Noble metal is then precipitated, and reduced or rendered insoluble, so that reverse micelles have particles of noble metal formed therein, which are deposited.

Japanese Patent Application Laid-Open Publication No. 2000-42411 has disclosed a catalyst production method employing a reversed micelle method. First, particles of noble metal are formed by the reversed micelle method, and particles of co-catalytic metal (e.g. oxygen occluding metal particles). Then, by an impregnation method, a prescribed amount of particles of noble metal and a necessary amount of co-catalytic metal particles are held on a carrying substrate. Or, noble metal particles and co-catalytic metal particles are mixed together in a reduced or hydroxided state, to be held on a carrying substrate.

### DISCLOSURE OF THE INVENTION

However, it is difficult for the method described to form a desirable composite of noble metal particles and co-catalytic metal particles, so that the contact area between noble metal particle and co-catalytic metal particle is reduced to be insufficient for co-catalytic metal particles to exhibit their inherent performance (e.g. oxygen occluding ability). Further, the catalytic activity is reduced, with an amount of co-catalytic metal particles added with an amount of noble metal particles reduced.

In particular, upon exposure to a high temperature environment, the catalyst, which includes a substrate (e.g. metal oxide) carrying thereon noble metal particles and co-catalytic metal particles, has noble metal particles moved along substrate surfaces, sintering with the substrate, thus forming a complex oxide therebetween, resulting in a remarkable reduction in catalytic activity.

The present invention has been achieved as a solution to such points.

According to an aspect of the invention, a heat-resistive catalyst comprises a composite particle comprising a noble metal particle, and a co-catalytic metal compound particle contacting as a metal with the noble metal particle, and a substrate carrying the noble metal particle and the co-catalytic metal compound particle.

According to another aspect of the invention, a heat-resistive catalyst comprises a composite particle comprising a noble metal particle, and a co-catalytic metal compound particle contacting as an oxide with the noble metal particle, and a substrate carrying the noble metal particle and the co-catalytic metal compound particle.

According to another aspect of the invention, a production method of heat-resistive catalyst comprises having a noble metal salt aqueous solution and a co-catalytic metal salt aqueous solution concurrently provided in a reverse micelle, preparing reverse micellar solution containing a noble metal precursor and a co-catalytic metal precursor, and having a substrate carrying a composite particle comprising the noble metal precursor and the co-catalytic metal precursor concurrently reduced as a noble metal particle and a co-catalytic metal particle, respectively.

The above and further objects, features, and advantages of the invention will more fully appear from the best mode for carrying out the invention, when the same is read in conjunction with the accompanying drawings.

### BRIEF DESCRIPTION OF DRAWINGS

FIG. 1 is a schematic process chart of a method of producing a heat-resistive catalyst by a co-reduction according to an embodiment of the invention.

FIG. 2 is a process chart of a method of producing a heat-resistive catalyst by a co-reduction in an aluminium isopropoxide (Al-isoP) clathrate compound.

FIG. 3 is a process chart of a method of producing a heat-resistive catalyst by a co-reduction in an Al nitrate clathrate compound.

FIG. 4 is a process chart of a method of producing a catalyst in a Comparative Example 2 by a co-reduction in an aluminium isopropoxide (Al-isoP) clathrate compound.

### BEST MODE FOR CARRYING OUT THE INVENTION

There will be described below heat-resistive catalysts and production methods thereof according to embodiments as best modes for carrying out the present invention.

Description is first made of the composition of a high heat-resistant catalyst according to an embodiment of the invention.

The heat-resistive catalyst has a complex of noble metal particles and co-catalytic metal compound particles, as a fine composite particle held on a carrying substrate, i.e., carried by or on the substrate.

In a molecular-level observation in light of an aspect of the embodiment, the composite particle is composed with a particle of a co-catalytic metal compound, e.g., transition metal compound contacting as a metal, i.e. in a metal state, with a noble metal particle.

The contact between a noble metal particle and a co-catalytic transition metal compound particle in a metal state gives rise to an increased tendency for electrons to move in between, promoting a spillover effect, causing the noble metal particle to have an enhanced catalytic activity.

The spillover effect has an increased influence, as the contact area between noble metal particle and transition metal compound particle extends. It therefore is desirable to make smaller the sizes or diameters of noble metal particles and transition metal compound particles, rendering greater the contact area between noble metal and transition metal compound particles.

The formation of a composite particle shortens distances between molecules as well as atoms of involved noble metal particles and transition metal compound particles, with additional contribution to the extension of contact area between noble metal and transition metal compound particles.

For a catalyst having an extended contact area between noble metal and transition metal compound particles, it is ensured in the form of an exhaust gas purifying catalyser mounted on a vehicle, that reaction gases reach the transition metal, even in use within a stoichiometric range where the amount of reductant is equivalent to the oxygen amount of reaction gases.

The catalyst, which contains transition metal compound particles, enters a reduced state with an increased tendency to be active in catalysis, having an enhanced catalytic activity relative to a case employing noble metal particles alone.

In a molecular-level observation in light of another aspect of the embodiment, the composite particle is composed with a particle of a co-catalytic metal compound, e.g., rare earth element compound or Zr-containing compound, contacting as an oxide, i.e. in an oxide state, with a noble metal particle.

The contact between a noble metal particle and a rare earth element compound particle in an oxide state promotes an oxygen absorbing/desorbing effect. For a catalyst containing rare earth element compound particles, in the form of a vehicle-mounted exhaust gas purifying catalyser, it is ensured, even in variations from the stoichiometric range of reaction atmosphere, where the amount of reductant is equivalent to the oxygen amount, to an oxygen-lean range or to an oxygen-rich range, that the oxygen absorbing/desorbing effect of rare earth element compound particles has a sufficient influence to keep noble metal particles in a metal state with an enhanced activity in catalysis, while the oxygen absorbing/desorbing effect has a significant contribution to controlling noble metal particles against variations of atmosphere, which otherwise might cause a deactivation of such noble metal particles due to a sintering or a transition to a solid solution in the substrate (porous oxide).

The oxygen absorbing/desorbing effect has an increased influence, with an extended area by which rare earth element compound particles contact in an oxide state with noble metal particles.

It therefore is desirable to make smaller the sizes or diameters of noble metal particles and rare earth element compound particles, rendering greater the contact area between noble metal and rare earth element compound particles.

The formation of a composite particle having a Zr-containing particle contacting in an oxide state with a noble metal particle provides an excellent catalyst in anti-corrosion.

In the aspects of embodiment described, the co-catalytic transition metal compound particle may preferably be one of a simplex oxide, a complex oxide, a metal (of a 0 valence), and an alloy.

Metal compounds therefore may preferably contain one or more transition metal elements selected from among Fe, Co, Ni, Cu, Ti, and W, with a preference to (an) optimal metal(s) in respect of the use or kind of catalyst. Such (a) preferable metal(s) should hardly form a solid solution with an oxide substrate, allowing for an enhanced catalytic activity per unit mass of noble metal particles.

The co-catalytic metal compound particle may preferably contain a compound of a rare earth element (e.g. Ce, La) or an element (e.g. Zr) having an oxygen absorbing/desorbing effect.

The noble metal particle may preferably contain one or more noble metals selected from among Ru, Rh, Pd, Ag, Ir, Pt, and Au, with a preference to (an) optimal noble metal (s) in respect of the use or kind of catalyst.

Any noble metal particle may contain one or more kinds of noble metal. For example, in production of a catalyst, a Pt salt and an Rh salt may be mixed in a reverse micelle, where they may be reduced to form a Pt-Rh composite particle, which may be carried on a surface of a metal oxide. Among such noble metals, a particular preference may be given to Pt, Pd, and Rh that are relatively high in catalytic activity.

Any composite particle may have one or more kinds of co-catalytic metal. For example, in production of a catalyst, a Co salt and a Ni salt may be admixed in a reverse micelle, where they may be reduced to form a composite particle having (a) noble metal particle(s) and (a) transition metal particle(s) containing a Co oxide and a Ni oxide, which composite particle may be carried on a surface of a metal oxide.

The carrying substrate may preferably be a porous oxide material composed of one or more oxides selected from among an alumina, a cerium oxide, a titanium oxide, a zirconia, and a silica.

Description is now made of a production method of heat-resistive catalyst according to an embodiment of the invention.

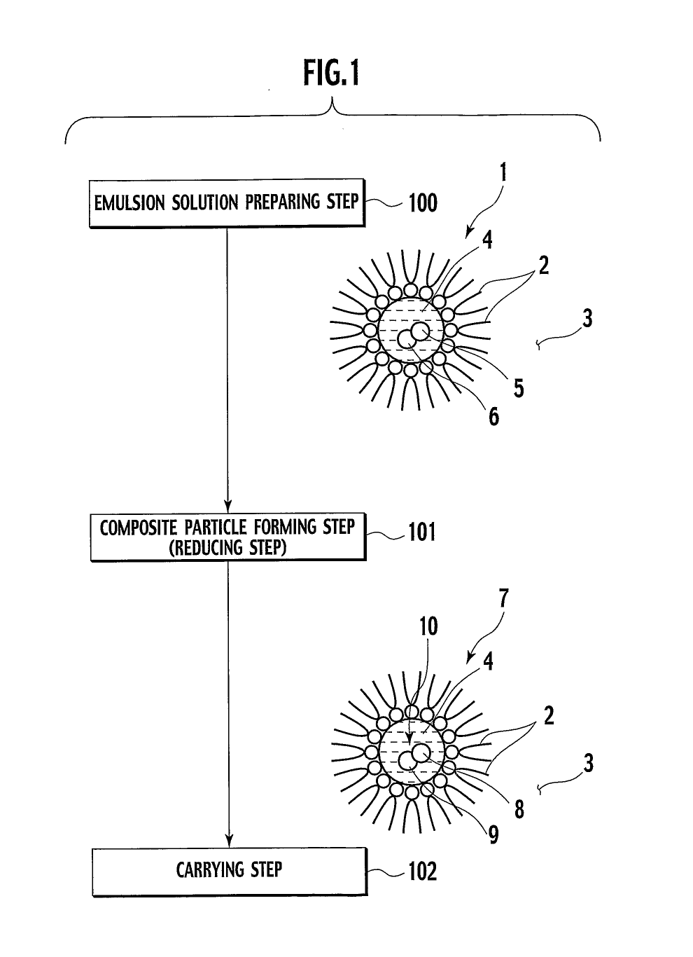

As illustrated in FIG. 1, the production method of heat-resistive catalyst includes an emulsion (reverse micellar solution) preparing process 100, a composite particle forming process 101, and a particle carrying process 102.

The emulsion preparing process 100 includes a step of mixing, in an organic solvent, a surfactant, a noble metal salt aqueous solution, and a co-catalytic metal salt aqueous solution, thereby preparing an emulsion with a multiplicity of dispersed reverse micelles each having noble metal salt aqueous solution and co-catalytic metal salt aqueous solution coexisting therein.

As shown in FIG. 1, a respective reverse micelle 1 is formed spherical by surfactant molecules 2, with a diameter of approx. tens of nm. The reverse micelle 1 has an exterior of an oil phase 3, and an interior of a water phase 4. The water phase 4 has one or more noble metal precursors 5 (noble metal salt) and one or more co-catalytic metal precursors 6 (e.g. transition metal salt) coexisting therein, so that the noble metal and co-catalytic metal precursors 5 and 6 are uniformly mixed at a molecule level in the interior of reverse micelle 1.

The composite particle forming process 101 includes a (reduction) step of mixing a reductant in the emulsion, for a concurrent reduction of a respective noble metal precursor 5 (noble metal salt) and a respective co-catalytic metal precursor 6 (e.g. transition metal salt) in reverse micelle 1 to form a composite particle 10 having a corresponding noble metal particle 8 and a corresponding catalytic metal compound particle 9. FIG. 1 illustrates a reverse micelle 7 after reduction, which has a composite particle 10 formed therein with a noble metal particle 8 and a co-catalytic metal compound particle 9.

The particle carrying process 102 includes a step of having composite particles held on a carrying substrate. This step may preferably be performed by one of first to third methods described below, as it is selective depending on use or kind of metals or metal salts in reverse micelle.

The first method employs a hydrolyzate of metal alkoxide for clathration. More specifically, to provide a precursor of the substrate (porous oxide), a metal alkoxide or a hydrolyzate of metal alkoxide is mixed in the emulsion, where it enters reverse micelles, whereby composite particles are mixed therewith to provide a resultant mixture.

Then, a solvent of the mixture is removed to provide dried powder, which is fired to provide catalyst powder.

As the result, a heat-resistive catalyst is obtained, in which composite particles (of noble metal particle and co-catalytic metal compound particle) several nm to several tens nm in size are carried by surfaces of a substrate composed of (a) metal oxide(s).

The second method employs a precipitant for insolubilization of substrate salt. More specifically, a aqueous solution of a salt of a precursor of substrate (porous oxide) and a precursor salt of substrate (porous oxide) are precipitated or insolubilized as a hydroxide by a mixing of precipitant or insolubilizer, before a firing to have composite particles (noble metal particle and co-catalytic metal compound particle) carried by substrate surfaces.

The third method employs an impregnation for a carrying on substrate powder. More specifically, porous oxide powder is dispersed in a mixed solution, before a firing to have composite particles carried by surfaces of porous oxide (substrate).

Among the three methods described, the first method is most preferable, while the second method also is preferable. This is because, in the first method, alkoxide of porous oxide precursor is soon insolubilized by hydrolysis upon intrusion into reverse micelles, so that a manifest of insoluble alkoxide encloses composite particles (noble metal particle, co-catalytic metal compound particle), acting as a buffer for those particles. Catalysts produced by use of the first method can thus control noble metal particles against sintering, even under a high temperature condition.

In the production method of heat-resistive catalyst described, noble metal particles and co-catalytic metal compound particles are prepared in advance as water-soluble salts. In other words, noble metal precursors (noble metal ions) and co-catalytic metal precursors (metal ions) are uniformly mixed at a molecule level, before their reduction to form composite particles about several nm to several tens nm in size or diameter, in which co-catalytic metal compound particles contact in a metal state with noble metal particles.

As a result, noble metal particles and co-catalytic metal particles are rendered smaller in size or diameter, having an increased contact area between noble metal particle and co-catalytic metal compound particle, allowing an enhanced activity of the latter. When carried by substrate surfaces, such composite particles can be controlled from aggregation.

The metal compound particles have different activated states depending on the element or working conditions. To achieve a metal compound state, conditions may be changed, for example of reactant kind, reaction temperature, reaction time, stirring strength, and stirring method.

Description is now made of materials to be used in the production method of heat-resistive catalyst.

The noble metal salt may be one of dinitro-diammine Pt (II) nitric acid-acidic aqueous solution, hexachloro Pt(IV) acidic solution, hexaammine Pt(IV) tetrachloride solution, Pd chloride aqueous solution, palladium nitrate aqueous solution, dinitro-diammine Pd dichloride solution, rhodium chloride solution, rhodium nitrate solution, ruthenium chloride solution, ruthenium nitrate solution, and hexachloro iridic acid aqueous solution, for example.

Organic solvent may be one of cyclohexane, methylcyclohexane, cycloheptane, heptanol, octanol, dodecyl alcohol, cetyl alcohol, isooctane, n-heptane, n-hexane, n-decane, benzene, toluene, xylene, etc. There may be used a mixed solution of two or more of them. For example, reverse micelles containing noble metal particles and those containing co-catalytic metal compound particles may have different solutions prepared for use in the oil phase.

The surfactant may be one of polyoxyethylene nonylphenyl ether, magnesium laurate, zinc caprate, zinc myristate, sodium phenyl stearate, aluminum dicaprylate, tetra-isoamyl ammonium thiocyanate, n-octadecyl tri-n-butyl ammonium formate, n-amyl tri-n-butyl ammonium iodide, sodium bis(2-ethylhexyl)succinate, sodium dinonyl naphthalene sulfonate, calcium cetyl sulfate, dodecyl amine oleate, dodecyl amine propionate, cetyltrimethylammonium bromide, stearyl trimethylammonium bromide, cetyltrimethylammonium chloride, stearyl trimethylammonium chloride, dodecyl trimethylammoniumbromide, octadecyl trimethylammoniumbromide, dodecyl trimethylammonium chloride, octadecyl trimethylammonium chloride, di-dodecyl dimethylammonium bromide, di-tetradecyl dimethylammonium bromide, di-dodecyl ditrimethylammonium chloride, di-tetradecyl dimethylammonium chloride, (2-octyloxy-1-octyloxymethyl)polyoxyethylene ethyl ether, etc. There may be used a mixed solution of two or more of them. For example, reverse micelles containing noble metal particles and those containing co-catalytic metal compound particles may have different solutions used for preparation of the surfactant.

The reductant maybe one of hydrazine, sodium hydroborate, sodium thiosulfate, citric acid, sodium citrate, L-ascorbic acid, sodium borohydride, formic acid, formaldehyde, methanol, ethanol, ethylene, vitamin B, etc. There may be used a mixed solution of two or more of them.

The precipitant may be ammonia water, tetramethylammonium hydroxide, or the like that is available to obtain hydroxides of associated noble metal and co-catalytic metal.

### EXAMPLES

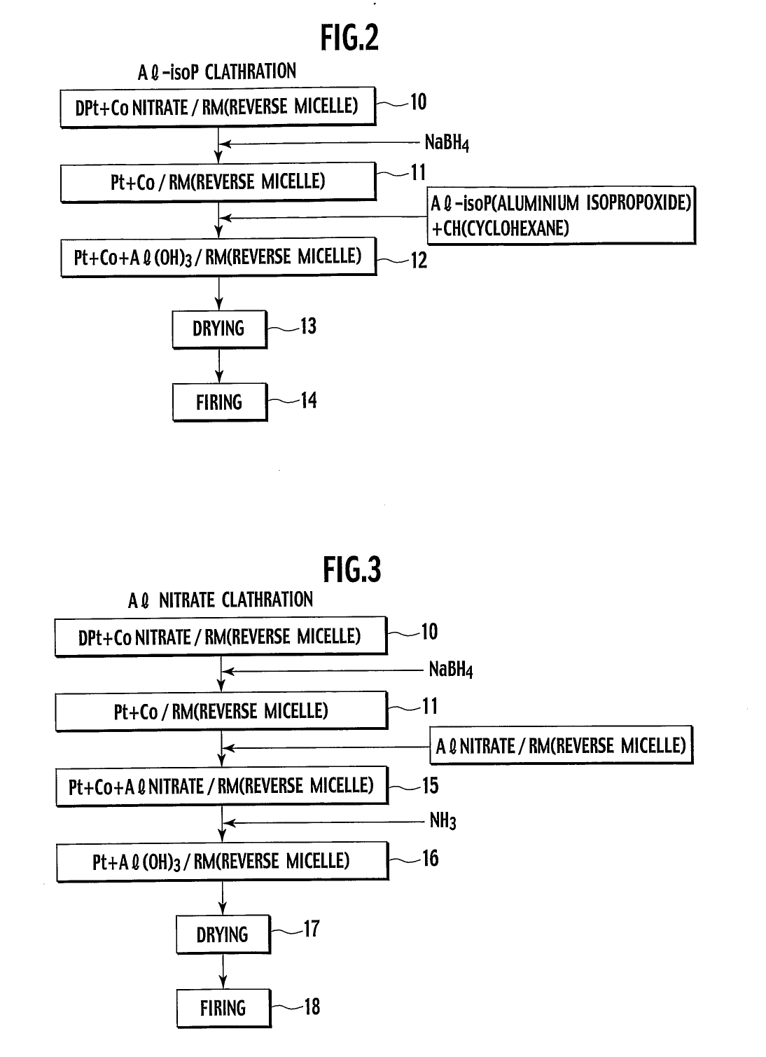

Examples of embodiment will be described with reference to FIG. 2 through FIG. 4.

### Example 1

In Example 1, a catalyst powder was created by co-reduction in aluminium isopropoxide (Al-isoP) clathrate compound in FIG. 2.

Added to 66 g of polyethylene glycol (5) mono-4-nonylphenyl ether as a surfactant was 1000 ml of cyclohexane as solvent, thereby preparing a solution including 0.15 mol % of surfactant, and the solution was then stirred. Meanwhile, added into 7.73 ml of pure water were 0.37 g of dinitro-diamine Pt nitric acid-acidic aqueous solution (Pt concentration was 8.46 wt. %) and 0.26 g of cobalt nitrate hexahydrate powder, and they were there after mixed and stirred. Thereafter, the prepared solutions were mixed, and stirred for about 2 hours, thereby subsequently obtaining reverse micellar solution including ions of Pt and Co (step 10).

Next, 0.12 g of NaBH₄ was added to the emulsion, followed by stirring for 2 hours, thereby obtaining reverse micellar solution including reduced composite particles (Pt—Co) (step 11).

Further, there was prepared a mixed solution by adding 20 ml of cyclohexane to 4.0 g of aluminium isopropoxide, and the prepared mixed solution was dropped into the emulsion including reduced Pt—Co composite particles, followed by stirring for about 2 hours. After stirring, reduced Pt—Co composite particles were clathrated by Al hydroxide (step 12).

120 ml of methanol was dropped into the emulsion including Pt—Co composite particles clathrated by Al hydroxide, thereby breaking reverse micelles, followed by stirring for about 2 hours, and filtration for separation from the solvent. Thus obtained precipitate was washed by alcohol to remove excessive surfactant. This precipitate was dried at 100° C. for 12 hours (step 13), and fired at 400° C. in airflow (step 14), thereby obtaining catalyst powder in which 3 wt. % of Pt and 5 wt. % of Co were carried on every 1 g of Al₂O₃.

Next, 50 g of the catalyst powder obtained by repeating the above manipulations, 5 g of boehmite, and 157 g of 10% nitric-acid-containing aqueous solution were charged into an alumina-made porcelain pot, and shaken and ground together with alumina balls, thereby obtaining a catalyst slurry. Further, the catalyst slurry was loaded onto a honeycomb substrate made of cordierite (900 cell/2.5 mil, 0.06 L) and an excessive slurry was removed by airflow, followed by drying at 120° C. and firing thereafter at 400° C. in airflow, thereby coating the catalyst to obtain a catalyst of Example 1.

### Example 2

The same procedure as Example 1 was used except that 0.16 g of hydrazine was added instead of NaBH₄ in the step 11 in Example 1, thereby creating catalyst powder of Example 2. Further, 500 g of thus obtained catalyst powder was used and coated onto a honeycomb carrier like to the procedure of Example 1, thereby obtaining a catalyst of Example 2.

### Example 3

In Example 3, a catalyst powder was created by co-reduction in Al nitrate clathrate compound in FIG. 3.

The same procedure as Example 1 was used up to the step 11, while using a nickel nitrate hexahydrate powder as the metal in the step 10 for Example 1. Here, an Al nitrate solution obtained by adding 7.36 g of Al nitrate to 2 ml of pure water, was added and mixed into a solution obtained by adding 225.7 ml of cyclohexane to 14.9 g of polyethylene glycol(5) mono-4-nonylphenyl ether, followed by stirring for about 2 hours, thereby preparing reverse micellar solution containing Al nitrate.

The reverse micellar solution including Pt—Ni composite particle and the reverse micellar solution Al nitrate were mixed, followed by stirring for about 2 hours, thereby obtaining reverse micellar solution in which Pt—Ni composite particle is mixed with Al nitrate (step 15).

Dropped into this emulsion was 70.5 g of 25% ammonia water, whereby the Al nitrate was insolubilized as Al hydroxide, followed by further stirring for about 2 hours (step 16). 122.6 ml of methanol was added to the prepared mixed solution to thereby break micelles, followed by stirring for about 2 hours, and filtration for separation from the solvent. Thus obtained precipitate was washed by alcohol to remove excessive surfactant. Further, this precipitate was dried at 100° C. for 12 hours (step 17), and then fired at 400° C. in airflow (step 18), thereby obtaining catalyst powder in which 3 wt. % of Pt and 5 wt. % of Ni were carried on every lg of Al₂O₃.

50 g of thus obtained catalyst powder was used and carried on a honeycomb carrier by the same procedure as Example 1, thereby obtaining a catalyst of Example 3.

### Example 4

In Example 4, a catalyst powder was created by a procedure of impregnation into Al₂O₃.

The same procedure as the step 10 and step 11 of Example 1 was used, thereby obtaining reverse micellar solution including reduced Pt—CO composite particles.

Further, a mixed solution obtained by dispersing 1 g of γ-Al₂O₃ into 20 ml of cyclohexane and the reverse micellar solution including reduced Pt—CO composite particles are mixed, for adsorption of reverse micelles to be carried on surfaces of Al₂O₃, followed by further stirring for 2 hours.

122.6 ml of methanol was added into the prepared mixed solution to thereby breaking reverse micelles, followed by stirring for about 2 hours, and filtration for separation from the solvent. Thus obtained precipitate was washed by alcohol to remove excessive surfactant. Further, this precipitate was dried at 100° C. for 12 hours, and then fired at 400° C. in airflow, thereby obtaining catalyst powder in which 3 wt. % of Pt and 5 wt. % of Co were carried on every 1 g of Al₂O₃.

50 g of catalyst powder obtained by repeating the above manipulations was used and carried on a honeycomb carrier by the same procedure as Example 1, thereby obtaining a catalyst of Example 4.

### Example 5

In Example 5, a catalyst powder was created by co-reduction in Al nitrate clathrate compound in FIG. 3 to add Ce afterward.

There was prepared a solution including 0.15 mol %/L of surfactant by adding 1,000 ml of cyclohexane to 66 g of polyethylene glycol (5) mono-4-nonylphenyl ether, followed by stirring. Meanwhile, added into 7.64 ml of pure water were 0.44 g of dinitro-diamine Pt nitric acid-acidic aqueous solution (Pt concentration: 8.46 wt. %), and 0.46 g of iron nitrate nonahydrate powder, and then they were mixed and stirred. Thereafter, the solution including noble metal and transition metal was added into the prepared solution including surfactant, and they were stirred for about 2 hours, thereby subsequently obtaining reverse micellar solution including ions of Pt and Fe.

Next, added into the reverse micellar solution including Pt and Fe ions was 0.12 g of NaBH₄, followed by stirring for 2 hours, thereby obtaining reverse micellar solution including reduced Pt—Fe composite particles.

Then, a solution obtained by mixing 7.36 g of aluminum nitrate nonahydrate, 1.05 g of cerium nitrate hexahydrate and 5.4 ml of pure water was added to be mixed in a solution obtained by adding 237.1 ml of cyclohexane to 15.7 g of polyethylene glycol (5) mono-4-nonylphenyl ether, was, followed by stirring for about 2 hours.

The prepared emulsion including Pt—Fe composite particles and the prepared reverse micellar solution including Al nitrate and Ce nitrate were mixed, followed by stirring for about 2 hours, thereby subsequently obtaining reverse micellar solution including Pt—Fe composite particles and Al nitrate and Ce nitrate. Dropped into this solution was 71 g of 25% ammonia water to thereby insolubilize Al nitrate and Ce nitrate, followed by stirring for about 2 hours.

122.6 ml of methanol was added to the prepared mixed solution, thereby breaking the reverse micelles, followed by stirring for about 2 hours, and filtration for separation from the solvent. Thus obtained precipitate was washed by alcohol to remove excessive surfactant. This precipitate was dried at 100° C. for 12 hours, and then fired at 400° C. in airflow, thereby obtaining catalyst powder.

50 g of the catalyst powder obtained by repeating the above manipulations was used and coated onto a honeycomb carrier by the same procedure as Example 1, thereby obtaining a catalyst of Example 5.

### Example 6

In Example 6, a catalyst powder was created by Pt—Co—Ce co-reduction in aluminium isopropoxide (Al-isoP) clathrate compound in FIG. 2.

There was prepared a solution including 0.15 mol %/L of surfactant by adding 1,000 ml of cyclohexane to 66 g of polyethylene glycol (5) mono-4-nonylphenyl ether, and this was stirred. Meanwhile, added into 7.56 ml of pure water were 0.37 g of dinitro-diamine Pt nitric acid-acidic aqueous solution (Pt concentration: 8.46 wt. %) , and cobalt nitrate hexahydrate powder and cerium nitrate, and they were mixed and then stirred. Thereafter, a solution including noble metal and transition metals was added into the prepared solution including surfactant, and they were stirred for about 2 hours, thereby subsequently preparing an emulsion with Pt—Co—Ce reverse micelles including ions of Pt, Co and Ce.

Next, added into the emulsion with Pt—Co—Ce reverse micelles was 0.12 g of NaBH₄, followed by stirring for 2 hours, thereby obtaining an emulsion including Pt—Co—Ce composite particles.

Meanwhile, there were prepared a solution having 7.36 g of aluminum nitrate nonahydrate mixed in 5.2 ml of pure water, and a solution having 15.7 g of polyethylene glycol(5) mono-4-nonylphenyl ether mixed in 226 ml of cyclohexane, and then the prepared solutions were mixed together, followed by stirring for about 2 hours.

Added and mixed to the reverse micellar solution including Pt—Co—Ce composite particles was reverse micellar solution including Al nitrate, followed by stirring for about 2 hours, thereby obtaining reverse micellar solution having Pt—Co—Ce composite particles and Al nitrate mixed therein. Dropped into this emulsion was 71 g of 25% ammonia water, thereby insolubilizing Al nitrate, followed by further stirring for about 2 hours.

Further, after preparation for mixing Pt—Co—Ce composite particles and insolubilized Al nitrate in reverse micelles, 122.6 ml of methanol was added to break the reverse micelles, followed by stirring for about 2 hours, and filtration for separation from the solvent. Thus obtained precipitate was washed by alcohol to remove excessive surfactant. This precipitate was dried at 100° C. for 12 hours, and then fired at 400° C. in airflow, thereby obtaining catalyst powder containing Pt—Co—Ce composite particles carried on surfaces of Al₂O₃.

50 g of catalyst powder obtained by repeating the above manipulations was used and coated onto a honeycomb carrier by the same procedure as Example 1, thereby obtaining a catalyst of Example 6.

### Example 7

In Example 7, a catalyst powder was created by Pt—Rh—Co co-reduction in aluminium isopropoxide (Al-isoP) clathrate compound in FIG. 2.

There was prepared a solution including 0.15 mol %/L of surfactant by adding 1,000 ml of cyclohexane to 66 g of polyethylene glycol (5) mono-4-nonylphenyl ether, and this was stirred. Meanwhile, added into 7.56 ml of pure water were 0.37 g of dinitro-diamine Pt nitric acid-acidic aqueous solution (Pt concentration: 8.46 wt. %) and 0.103 g of rhodium nitrate aqueous solution (Rh concentration: 5.83 wt. %), and 0.26 g of a cobalt nitrate hexahydrate powder, and they were mixed and then stirred.

Thereafter, the solution including the noble metals and the metal was added into the prepared solution including surfactant, and they were stirred for about 2 hours, thereby subsequently preparing reverse micellar solution including ions of Pt, Rh and Co.

Next, added into the emulsion was 0.12 g of NaBH₄, followed by stirring for 2 hours, thereby obtaining reverse micellar solution including reduced Pt—Rh—Co composite particles.

Further, there were prepared a solution having 7.36 g of aluminum nitrate nonahydrate mixed in 5.2 ml of pure water, and a solution having 15.7 g of polyethylene glycol(5) mono-4-nonylphenyl ether added to 226.0 ml of cyclohexane, and then the prepared solutions were mixed together, followed by stirring for about 2 hours.

Added and mixed to the prepared reverse micellar solution including Pt—Rh—Co composite particles was the prepared reverse micellar solution including Al nitrate, followed by stirring for about 2 hours, thereby obtaining reverse micellar solution having Pt—Rh—Co composite particles and Al nitrate mixed therein. Dropped into this emulsion was 71 g of 25% ammonia water to thereby insolubilize Al nitrate, followed by stirring for about 2 hours.

122.6 ml of methanol was added to the reverse micellar solution having Pt—Rh—Co composite particles and insolubilized Al nitrate mixed therein, thereby breaking the reverse micelles, followed by stirring for about 2 hours, and filtration for separation from the solvent. Thus obtained precipitate was washed by alcohol to remove excessive surfactant. This precipitate was dried at 100° C. for 12 hours, and then fired at 400° C. in airflow, thereby obtaining catalyst powder containing Pt—Rh—Co composite particles carried on surfaces of Al₂O₃.

50 g of catalyst powder obtained by repeating the above manipulations was used and coated onto a honeycomb carrier by the same procedure as Example 1, thereby obtaining a catalyst of Example 7.

### Example 8

In Example 8, a catalyst powder was created by the same procedure as Example 1, except for adding iron nitrate nonahydrate instead of cobalt nitrate hexahydrate in the step 10 of Example 1, so that the concentration of particles carried on Al₂O₃ became 5 wt. %, thereby obtaining catalyst powder. Further, 50 g of thus obtained catalyst powder was used and coated onto a honeycomb carrier, thereby obtaining a catalyst of Example 8.

### Example 9

In Example 9, a catalyst powder was created by the same procedure as Example 1, except for adding nickel nitrate hexahydrate instead of cobalt nitrate hexahydrate in the step 10 of Example 1, so that the concentration of particles carried on Al₂O₃ became 5 wt. %, thereby obtaining catalyst powder. Further, 50 g of catalyst powder obtained by repeating the above manipulations was used and coated onto a honeycomb carrier, thereby obtaining a catalyst of Example 9.

### Example 10

In Example 10, a catalyst powder was created by the same procedure as Example 1, except for adding a palladium nitrate aqueous solution instead of the dinitro-diamine Pt nitric acid-acidic aqueous solution and a lanthanum oxide nitrate hexahydrate instead of the cobalt nitrate hexahydrate in the step 10 of Example 1, so that the concentrations of particles carried on Al₂O₃ were 3 wt. % and 5 wt. %, respectively, thereby obtaining catalyst powder. Further, 50 g of catalyst powder obtained by repeating the above manipulations was used and coated onto a honeycomb carrier, thereby obtaining a catalyst of Example 10.

### Example 11

In Example 11, a catalyst powder was created by the same procedure as Example 1, except for adding a rhodium nitrate aqueous solution instead of the dinitro-diamine Pt nitric acid-acidic aqueous solution and a zirconium(IV) oxide nitrate hydrate instead of the cobalt nitrate hexahydrate in the step 10 of Example 1, so that the concentrations of particles carried on Al₂O₃ were 3 wt. % and 5wt. %, respectively, thereby obtaining catalyst powder. Further, 50g of catalyst powder obtained by repeating the above manipulations was used and coated onto a honeycomb carrier, thereby obtaining a catalyst of Example 11.

### Example 12

In Example 12, a catalyst powder was created by the same procedure as Example 1, except for adding dinitro-diamine Pt nitric acid-acidic aqueous solution in the step 10 of Example 1, so that the concentration of particles carries on Al₂O₃ became 3 wt. %, thereby obtaining catalyst powder. Further, 50 g of catalyst powder obtained by repeating the above manipulations was used and coated onto a honeycomb carrier, thereby obtaining a catalyst of Example 12.

### Comparative Example 1

In Comparative Example 1, a catalyst including noble metal only was created in a similar procedure to Example 1.

There was prepared a solution including 0.15 mol %/L of surfactant by adding 1,000 ml of cyclohexane to 66 g of polyethylene glycol(5) mono-4-nonylphenyl ether, and this was stirred. Meanwhile, added into 7.7 ml of pure water was 0.37 g of dinitro-diamine Pt nitric acid-acidic aqueous solution (Pt concentration: 8.46 wt. %) , and they were mixed and then stirred.

Thereafter, the solution including noble metal was added into the prepared solution including surfactant, and it was stirred for about 2 hours, thereby subsequently preparing reverse micellar solution including Pt ion.

Next, added into the reverse micellar solution including Pt ion was 0.024 g of NaBH₄, followed by stirring for 2 hours, thereby obtaining reverse micellar solution including reduced reduced Pt particles.

Further, there was prepared a mixed solution by adding 20 ml of cyclohexane to 4.0 g of aluminium isopropoxide, and the prepared mixed solution was dropped into the reverse micellar solution including reduced reduced Pt particles, followed by stirring for about 2 hours.

After stirring, Pt particles were clathrated by Al hydroxide in reverse micelles.

100 ml of methanol was added to the reverse micellar solution including Pt particles clathrated by Al hydroxide, to break the reverse micelles, followed by stirring for about 2 hours, and filtration for separation from the solvent.

Thus obtained precipitate was washed by alcohol to remove excessive surfactant. This precipitate was dried at 100° C. for 12 hours, and then fired at 400° C. in airflow, thereby obtaining catalyst powder in which 3 wt. % of Pt was carried on every lg of Al₂O₃.

Further, 50 g of catalyst powder obtained by repeating the above manipulations was used and coated onto a honeycomb carrier by the same procedure as Example 1, thereby obtaining the catalyst of Comparative Example 1.

### Comparative Example 2

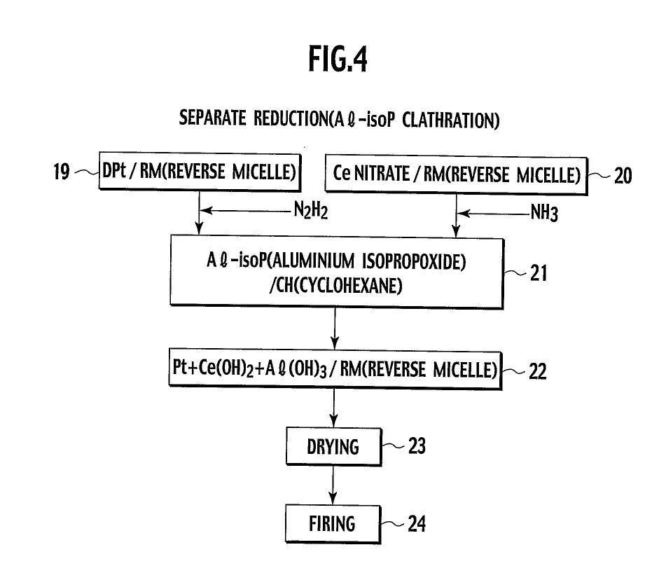

In Comparative Example 2, a catalyst powder was created by a co-reduction of Pt in aluminium isopropoxide (Al-isoP) clathrate compound in FIG. 4, followed by a separate reduction for reducing Co.

As shown in FIG. 4, there was first prepared a solution including 0.15 mol %/L of surfactant by adding cyclohexane to polyethylene glycol(5) mono-4-nonylphenyl ether, and this was stirred. Added and mixed to this solution were dinitro-diamine Pt nitric acid-acidic aqueous solution (Pt concentration: 8.46 wt. %) and N₂H₄, followed by stirring for about 2 hours, thereby preparing reverse micellar solution including reduced Pt (step 19).

Next, there was prepared a solution including 0.15 mol %/L of surfactant by adding cyclohexane to polyethylene glycol (5) mono-4-nonylphenyl ether like step 19, and this was stirred. Added and mixed into this solution were cerium nitrate and NaBH₄, followed by stirring for about 2 hours, thereby preparing reverse micellar solution including cerium hydroxide (step 20).

Thereafter, the emulsions prepared at step 19 and step 20 were dropped into a cyclohexane mixed solution including aluminium isopropoxide, thereby clathrating Pt and Co by Al hydroxide, followed by stirring for about 2 hours (step 21). 100 ml of methanol was added to the mixed solution prepared at step 21, to break the reverse micelles, followed by stirring for about 2 hours, and filtration for separation from the solvent.

Thus obtained precipitate was washed by alcohol to remove excessive surfactant (step 22). The precipitate was dried at 100° C. for 12 hours (step 23), and then fired at 400° C. in airflow (step 24), thereby obtaining catalyst powder in which 3 wt. % of Pt and 5 wt. % of Ce were carried on every lg of Al₂O₃.

Further, 50 g of catalyst powder obtained by repeating the above manipulations was used and coated onto a honeycomb carrier like to Example 1, thereby obtaining the catalyst of Comparative Example 2.

### Comparative Example 3

In Comparative Example 3, a catalyst powder was created by impregnation of Co followed by impregnation of Pt, using the impregnation method to Al₂O₃.

1 g of γ-Al₂O₃ was dispersed into a cobalt nitrate aqueous solution obtained by dissolving 0.26 g of cobalt nitrate hexahydrate into 1.2 ml of pure water, followed by stirring for about 1 hour. Thereafter, it was dried at a temperature of 150° C. for 12 hours to remove pure water, and further fired at 400° C. in airflow, thereby obtaining Al₂O₃ having carried 5% of Co.

Next, the Al₂O₃ powder having carried 5% of Co was dispersed in a solution obtained by adding 0.37 g of dinitro-diamine Pt nitric acid-acidic aqueous solution (Pt concentration: 8.46 wt. %) in 7.7 ml of pure water, followed by stirring for about 1 hour, drying at 150° C. for 12 hours, and firing at 400° C. for 1 hour in airflow, thereby obtaining Al₂O₃ powder having carried 3 wt. % of Pt and 5 wt. % of Co.

50 g of thus obtained Al₂O₃ catalyst powder having carried Pt and Co was used and coated onto a honeycomb carrier by the same procedure as Example 1, thereby obtaining the catalyst of Comparative Example 3.

The catalysts obtained in Examples 1 through 12 and Comparative Examples 1 through 3 were subjected to the following catalyst durability test, before evaluation of their catalytic performances.

The durability test employed a V-type 6-cylinder engine manufactured by Nissan Motor Co., Ltd., for which a lead-free gasoline was used as a fuel.

A jig adapted to adjust the flow rate of exhaust gases to a honeycomb carrier was employed for application to test-pieces in the durability test, which were sampled as exhaust-gas purifying catalysts from the catalysts obtained in Examples 1 through 12 and Comparative Examples 1 through 3.

Each sample had an adjusted catalyst position to set a catalyst inlet temperature to 700° C., and the engine was operated for 50 hours.

After the durability test, each sample was cut for an evaluation of catalytic performance to a catalyst capacity of 40 cc.

For the evaluation of catalytic performance, the composition of gas was conditioned to be stiochiometric between oxygen and reductant amounts, and a reaction gas of a composition shown in Table 1 was used.

TABLE 1
Reaction Gas Components

| Composition | Concentration |
|---|---|
| NO | 1,000 ppm |
| CO | 0.60% |
| H₂ | 0.20% |
| O₂ | 0.60% |
| CO₂ | 13.90% |
| C₃H₈ | 1,665 ppm |
| H₂O | 10 |
| N₂ | balance |

The performance evaluation for each catalyst having a catalyst capacity of 40 cc was conducted at a flow rate of reaction gas of 40 L/min and a reaction gas temperature of 350° C.

There was calculated an NOx purifying ratio (%) from a ratio based on a catalyst inlet NOx concentration and an outlet NOx concentration upon stabilization of these concentrations, and evaluation results are shown in Table 2 on the overleaf.

As shown in Table 2, there was exhibited the highest value of 58% for an NOx purifying ratio of Example 7 in which the catalyst powder was created by Pt—Rh—Co co-reduction in aluminium isopropoxide clathration, and the addition of Rh into the catalyst made it to have a catalytic activity higher than a situation of preparation by Pt only.

Although Comparative Example 1 carried Pt only and had an NOx purifying ratio of about 48%, the catalyst of Example 1 produced by the same procedure as Comparative Example 1 had an NOx purifying ratio increased to 54% by addition of Co as co-catalytic component into micelles in addition to Pt, thereby showing that its catalytic activity was enhanced as compared with Comparative Example 1. Further, in Example 12, although the amount of used Pt was so decreased by setting the carried concentration of Pt to be 0.50%, it was possible to obtain an NOx purifying ratio of 49% by carrying a co-catalytic component on a substrate by setting the carried concentration of Co to be 5.0%.

As a result, it was shown that catalytic activities are enhanced by carrying co-catalytic components on substrates even when carried concentrations of noble metals are decreased and thus usage amounts of the noble metals are decreased.

While preferred embodiments of the present invention have been described using specific terms, such description is for illustrative purposes, and it is to be understood that changes and variations may be made without departing from the spirit or scope of the following claims.

| | | | | | | | | | | | | Coating | |
|---|---|---|---|---|---|---|---|---|---|---|---|---|---|
| | | | | | | | Metal element | | | | Insolubi- | amount | |
| | | | | Metal element | | | to be added | | | | lizing | onto | ηNox@350° C. |
| | | Noble metal | | (co-cat. comp.) | | Re- | in post-step | | Precursor of | | agent | honey- | after |
| | | | Carried | | Carried | ducing | | Carried | porous oxide | | for metal | comb | endurance at |
| | | Kind | conc. (%) | Kind | conc. (%) | agent | Kind | conc. (%) | Kind | Precursor | (substrate) | (g/L) | 700° C. × 30 Hr |
| Example | 1 | Pt | 3.00 | Co | 5.0 | NaBH₄ | — | — | Al | Al isopropoxide | — | 100 | 54 |
| | 2 | Pt | 3.00 | Co | 5.0 | N₂H₂ | — | — | Al | Al isopropoxide | — | 100 | 56 |
| | 3 | Pt | 3.00 | Ni | 5.0 | NaBH₄ | — | — | Al | Al nitrate | ammo. | 100 | 52 |
| | | | | | | | | | | | water | | |
| | 4 | Pt | 3.00 | Co | 5.0 | NaBH₄ | — | — | Al | None (impreg. | — | 100 | 52 |
| | | | | | | | | | | into Al₂O₃) | — | 100 | 52 |
| | 5 | Pt | 3.00 | Fe | 5.0 | NaBH₄ | Ce | 10.0 | Al | Al nitrate | ammo. | 100 | 51 |
| | | | | | | | | | | | water | | |
| | 6 | Pt | 3.00 | Co | 5.0 | NaBH₄ | — | — | Al | Al isopropoxide | — | 100 | 51 |
| | | | | Ce | 10.0 | | | | | | | | |
| | 7 | Pt | 3.00 | Zr | 5.0 | NaBH₄ | — | — | Al | Al isopropoxide | — | 100 | 58 |
| | | Rh | 0.60 | | | | | | | | | | |
| | 8 | Pt | 3.00 | Fe | 5.0 | NaBH₄ | — | — | Al | Al isopropoxide | — | 100 | 51 |
| | 9 | Pt | 3.00 | Ni | 5.0 | NaBH₄ | — | — | Al | Al isopropoxide | — | 100 | 51 |
| | 10 | Pd | 3.00 | La | 5.0 | NaBH₄ | — | — | Al | Al isopropoxide | — | 100 | 50 |
| | 11 | Rh | 3.00 | Zr | 3.5 | NaBH₄ | — | — | Al | Al isopropoxide | — | 100 | 50 |
| | 12 | Pt | 0.50 | Co | 5.0 | NaBH₄ | — | — | Al | Al isopropoxide | — | 100 | 49 |
| Com- | 1 | Pt | 3.00 | — | — | NaBH₄ | — | — | Al | Al isopropoxide | — | 100 | 48 |
| parative | 2 | Pt | 3.00 | — | — | N₂H₂ | Ce | 5.0 | Al | None (impreg. | — | 100 | 49 |
| Example | | | | | | | | | | into Al₂O₃) | | | |
| | 3 | Pt | 3.00 | — | — | — | Co | 5.0 | Al | None (impreg. | — | 100 | 50 |
| | | | | | | | (im- | | | into Al₂O₃) | | | |
| | | | | | | | preg.) | | | | | | |

### INDUSTRIAL APPLICABILITY

According to the present invention, there is provided a heat-resistive catalyst in which composite particles containing noble metal and co-catalytic metallic compound are carried on a substrate, whereby a co-catalytic effect of metallic compound is kept active even with a reduced amount of noble metal, allowing for a low-cost catalyst relatively free of deterioration in catalytic activity.

Further, according to the present invention, there is provided a production method of heat-resistive catalyst employing a reversed micelle method of having noble metal salt and co-catalytic metal salt co-existing in a reverse micelle for formation of composite particle, whereby a co-catalytic effect of metallic compound is promoted, allowing for a heat-resistive catalyst high of catalytic activity and low of cost.

1. A heat-resistive catalyst comprising:
a composite particle comprising a noble metal particle, and a co-catalytic metal compound particle contacting as a metal with the noble metal particle; and
a substrate carrying the noble metal particle and the co-catalytic metal compound particle.

2. A heat-resistive catalyst comprising:
a composite particle comprising a noble metal particle, and a co-catalytic metal compound particle contacting as an oxide with the noble metal particle; and
a substrate carrying the noble metal particle and the co-catalytic metal compound particle.

3. The heat-resistive catalyst as claimed in claim 1, wherein the co-catalytic metal compound particle comprises a transition metal compound.

4. The heat-resistive catalyst as claimed in claim 2, wherein the co-catalytic metal compound particle comprises one of a rare earth element compound and a compound containing Zr.

5. The heat-resistive catalyst as claimed in claim 1, wherein the substrate comprises a porous oxide having a surface carrying the composite particle.

6. The heat-resistive catalyst as claimed in claim 1, wherein the substrate comprises at least one porous oxide selected from among an alumina, a cerium oxide, a titanium oxide, a zirconia, and a silica.

7. The heat-resistive catalyst as claimed in claim 1, wherein the noble metal particle comprises at least one metal selected from among Ru, Rh, Pd, Ag, Ir, Pt, and Au.

8. The heat-resistive catalyst as claimed in claim 1, wherein the co-catalytic metal compound particle comprises a transition metal compound containing at least one transition metal selected from among Fe, Co, Ni, Cu, Ti, and W.

9. A production method of heat-resistive catalyst, comprising:
having a noble metal salt aqueous solution and a co-catalytic metal salt aqueous solution concurrently provided in a reverse micelle,
preparing reverse micellar solution containing a noble metal precursor and a co-catalytic metal precursor; and having a substrate carrying a composite particle comprising the noble metal precursor and the co-catalytic metal precursor concurrently reduced as a noble metal particle and a co-catalytic metal particle, respectively.

10. The production method of heat-resistive catalyst as claimed in claim 9, comprising providing a reductant to the emulsion, concurrently reducing the noble metal precursor and the co-catalytic metal precursor in the reverse micelle, forming the composite particle.

11. The production method of heat-resistive catalyst as claimed in claim 9, comprising:
mixing, in the reverse micelle, a hydrolyzate of alkoxide as a precursor of a porous oxide forming the substrate, having a mixture; and
firing the mixture, before carrying the composite particle by a surface of the porous oxide.

12. The production method of heat-resistive catalyst as claimed in claim 9, comprising mixing, in the reverse micelle, an aqueous solution of a precursor salt of a porous oxide forming the substrate and a precipitating agent or an insolubilizing agent for precipitating or insolubilizing the precursor salt of the porous oxide as a hydroxide, before a firing to carry the composite particle by a surface of the porous oxide.

13. The production method of heat-resistive catalyst as claimed in claim 9, comprising dispersing, in the emulsion, powder of a porous oxide forming the substrate, before a firing to carry the composite particle by a surface of the porous oxide.

14. The production method of heat-resistive catalyst as claimed in claim 9, wherein the noble metal salt aqueous solution comprises a metal salt aqueous solution of at least one metal selected from among Ru, Rh, Pd, Ag, Ir, Pt, and Au.

15. The production method of heat-resistive catalyst as claimed in claim 9, wherein the co-catalytic metal salt aqueous solution comprises a metal salt aqueous solution of at least one metal selected from among Fe, Co, Ni, Cu, Ce, Zr, La, Ti and W.

16. The production method of heat-resistive catalyst as claimed in claim 9, wherein the substrate comprises a porous oxide containing at least one oxide selected from among an alumina, a cerium oxide, a titanium oxide, a zirconia, and a silica.

17. The heat-resistive catalyst as claimed in claim 2, wherein the substrate comprises a porous oxide having a surface carrying the composite particle.

18. The heat-resistive catalyst as claimed in claim 2, wherein the substrate comprises at least one porous oxide selected from among an alumina, a cerium oxide, a titanium oxide, a zirconia, and a silica.

19. The heat-resistive catalyst as claimed in claim 2, wherein the noble metal particle comprises at least one metal selected from among Ru, Rh, Pd, Ag, Ir, Pt, and Au.

20. The heat-resistive catalyst as claimed in claim 2, wherein the co-catalytic metal compound particle comprises a transition metal compound containing at least one transition metal selected from among Fe, Co, Ni, Cu, Ti, and W.
